(19) United States
(12) Patent Application Publication
(10) Pub. No.: US 2010/0086457 A1
(43) Pub. Date: Apr. 8, 2010

(54) CATALYST AND METHOD OF MANUFACTURE

(75) Inventors: Grigorii Lev Soloveichik, Latham, NY (US); Oltea Puica Siclovan, Rexford, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/247,728

(22) Filed: Oct. 8, 2008

(51) Int. Cl. B01D 53/86; B01J 23/50; B01J 23/06; B01J 27/043; B01J 27/045; B01J 31/12; B01J 31/18; B01J 27/24

(52) U.S. Cl. 423/239.1; 502/330; 502/340; 502/216; 502/222; 502/223; 502/161; 502/200

(57) ABSTRACT

Disclosed herein is a catalyst composition comprising a bimetallic complex of silver and a second metal; the bimetallic complex being disposed upon a porous substrate; where the second metal is platinum, palladium, iron, cobalt, nickel, copper, cadmium or mercury and where atoms of silver and the second metal are bound by one or more bridging ligands.

### BACKGROUND OF THE INVENTION

1. Technical Field

This invention includes embodiments that may relate to catalysts. This invention includes embodiments that may relate to methods of making catalysts. This invention includes embodiments that may relate to articles that include catalysts.

2. Discussion of Art

Exhaust gas streams may contain nitrogen oxides (NOx), unburned hydrocarbons (HC), and carbon monoxide (CO). It may be sometimes desirable to control and/or reduce the amount of one or more of the exhaust gas stream constituents. NOx can be catalytically reduced to nitrogen with different reducing agents, e.g. ammonia or hydrocarbons. Exhaust gas streams may employ exhaust treatment devices including a catalyst to remove NOx from the exhaust gas stream.

Examples of exhaust treatment devices include: catalytic converters, evaporative emissions devices, scrubbing devices, particulate filters/traps, adsorbers/absorbers, and plasma reactors. Catalytic converters may include three-way catalysts, oxidation catalysts, selective catalytic reduction (SCR) catalysts, and the like. Scrubbing devices may remove hydrocarbon (HC), sulfur, and the like. Plasma reactors may include non-thermal plasma reactors and thermal plasma reactors.

Three way catalysts (TWC) deployed in catalytic converters may facilitate the reduction of NOx using CO and residual hydrocarbons. TWC may be effective over a specific operating range of both lean and rich fuel/air conditions and in a specific operating temperature range. This purification of the exhaust gas stream by the catalytic converter depends on the exhaust gas temperature. The catalytic converter works optimally at an elevated catalyst temperature, at or above about 300 degrees Celsius. The time period between when the exhaust emissions begin (i.e., “cold start”), until the time when the catalyst heats up to a light-off temperature, may be referred to as the light-off time. Light-off temperature is the catalyst temperature at which fifty percent (50 percent) of the emissions from the engine are being converted as they pass through the catalyst.

One method of heating the catalytic converter is to heat the catalyst by contact with high temperature exhaust gases from the engine. This heating, in conjunction with the exothermic nature of the oxidation reactions occurring at the catalyst, will bring the catalyst to light-off temperature. However, until the light-off temperature is reached, the exhaust gases pass through the catalytic converter relatively unchanged. In addition, the composition of the engine exhaust gas changes as the engine temperature increases from a cold start temperature to an operating temperature, and the TWC is designed to work best with the exhaust gas composition that is present at normal elevated engine operating temperatures.

Selective Catalytic Reduction (SCR) may use ammonia that is injected into the exhaust gas stream to react with NOx over a catalyst to form nitrogen and water. Three types of catalysts have been used, including base metal systems, noble metal systems and zeolite systems. The noble metal catalysts operate in a low temperature regime (240 degrees Celsius to 270 degrees Celsius), but are inhibited by the presence of SO₂. The base metal catalysts, such as vanadium pentoxide and titanium dioxide, operate in the intermediate temperature range (310 degrees Celsius to 400 degrees Celsius), but at high temperatures they tend to promote oxidation of SO₂ to SO₃. The zeolites can withstand temperatures up to 600 degrees Celsius and, when impregnated with a base metal, have an even wider range of operating temperatures. In addition, the use of ammonia as a reductant in a SCR system presents additional environmental problems due to ammonia slip.

SCR with hydrocarbons reduces NOx emissions. Organic compounds can selectively reduce NOx over a catalyst under excess O₂ conditions. However, the conversion efficiency was reduced outside the temperature range of 300 degrees Celsius to 400 degrees Celsius.

It may be desirable to have catalysts that can effect NOx reduction across a wide range of temperatures and operating conditions. It may be desirable to have a catalyst that can effect NOx reduction at lower temperatures such as 250 to 350 degrees Celsius. It may be desirable to have catalysts that can operate in transient conditions and with engines having a lower exhaust temperature. It may be desirable if the method and apparatus could be implemented on existing engines and did not use large inventories of chemicals. It may also be desirable to use components of a hydrocarbon fuel as a reductant for SCR.

### BRIEF DESCRIPTION OF THE INVENTION

Disclosed herein is a catalyst composition comprising a bimetallic complex of silver and a second metal; the bimetallic complex being disposed upon a porous substrate; where the second metal is platinum, palladium, iron, cobalt, nickel, copper, cadmium or mercury and where atoms of silver and the second metal are bound by one or more bridging ligands.

Disclosed herein is a catalyst composition, comprising a catalytic metal complex disposed upon a porous substrate; the catalytic metal complex having the structure in formula (I)

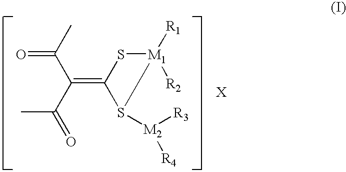

where M₁ is one of platinum, palladium, iron, cobalt, nickel, copper, cadmium or mercury and M₂ is silver, R₁, R₂, R₃ and R₄ are phosphine and X is ClO₄, BF₄, or NO₃.

Disclosed herein too is a catalyst composition, comprising a catalytic metal complex disposed upon a porous substrate; wherein the catalytic metal complex is a reaction product of a second metal complex, a silver salt and a second amount of a phosphine; and the second metal complex being a reaction product of a first metal complex, M₁Cl₂(NCPh)₂ and a first amount of a phosphine, wherein M₁ is one of platinum, palladium, iron, cobalt, nickel, copper, cadmium, or mercury; and the first metal complex being a reaction product of a metal acetylacetonate and a disulfide.

Disclosed herein is a method, comprising disposing a catalytic metal complex upon a porous substrate to form a catalyst composition; wherein the catalytic metal complex has the structure in formula (I)

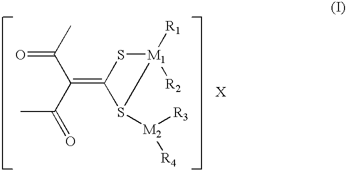

where M₁ is one of platinum, palladium, iron, cobalt, nickel, copper, cadmium or mercury and M₂ is silver, R₁, R₂, R₃ and R₄ are phosphines and X is ClO₄, BF₄, or NO₃.

### BRIEF DESCRIPTION OF THE DRAWING

FIG. 1 is a bar graph depicting NOx conversion at three different temperatures with Moctane reductant and using the catalyst compositions described in Table 1 and Example 1-Example 4.

FIG. 2 is a bar graph depicting NOx conversion at three different temperatures with C₁-C₃ reductant and using the catalyst compositions detailed in Table 1 and Example 1-Example 4.

FIG. 3 is a bar graph depicting NOx conversion at three different temperatures with a Moctane/C₁-C₃ mixture (ratio 50:50) reductant and using the catalyst compositions described in Table 1 and Example 1-Example 4.

### DETAILED DESCRIPTION OF THE INVENTION

This invention includes embodiments that may relate to catalysts. This invention includes embodiments that may relate to methods of making catalysts. This invention includes embodiments that may relate to articles that include catalysts.

The use of the terms “a” and “an” and “the” and similar references in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

As used herein, a catalyst is a substance that can cause a change in the rate of a chemical reaction without itself being consumed in the reaction. A metal complex is a chemical compound containing one or more metal atoms. A bridging ligand is a ligand that links two or more metal centers. A bridging ligand that binds through two sites is classified as bidentate, three sites as tridentate, and four or more sites as polydentate. A slurry is a mixture of a liquid and finely divided particles. A sol is a colloidal solution. A powder is a substance including finely dispersed solid particles. Templating refers to a controlled patterning; and, templated refers to determined control of an imposed pattern and may include molecular self-assembly. A monolith may be a ceramic block having a number of channels, and may be made by extrusion of clay, binders and additives that are pushed through a dye to create a structure. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

Disclosed herein is a catalytic metal complex for reducing NOx that is present in an exhaust gas stream including emissions generated from combustion in furnaces, ovens, and engines. A catalytic metal complex is an ensemble formed by the combination of ligands and metal ions that provides an alternative reaction route involving a different transition state and lower activation energy as compared to a reaction that is not mediated by a catalytic complex. The catalytic metal complex includes a metal complex disposed on a substrate. The substrate has pores of a size effective to prohibit aromatic species from poisoning the catalyst complex. When the catalytic metal complex is employed to reduce NOx generated in emissions from furnaces, ovens and engines, a variety of hydrocarbons can be effectively used as a reductant. In an exemplary embodiment, diesel fuel can be used as a reductant. In another exemplary embodiment, a light fraction of diesel fuel can be used as a reductant.

Disclosed herein is a catalyst composition comprising a bimetallic complex of silver and a second metal. The bimetallic complex is disposed upon a porous substrate. In one embodiment, the atoms of the second metal are bound by one or more bridging ligands. In an exemplary embodiment, the bridging ligands are bidentate ligands. The second metal is platinum, palladium, iron, cobalt, nickel, copper, cadmium or mercury. The catalytic metal complexes further comprise sulfur-containing ligands. The presence of sulfur-containing ligands stabilizes the catalytic metal complex against sulfur poisoning.

In one embodiment, the bimetallic complex is a heteronuclear alkylenedithialo complex having the structure in formula (I) below:

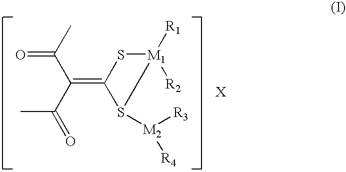

where the second metal M₁ is platinum (Pt), palladium (Pd), iron (Fe), cobalt (Co), nickel (Ni), copper (Cu), cadmium (Cd) or mercury (Hg) and M₂ is silver, R₁, R₂, R₃ and R₄ can be the same or different and are a triarylphosphine, an alkydiarylphosphines, a dialkylarylphosphines or a trialkylphosphine, and X is an anion that is ClO₄, BF₄, or NO₃. In an exemplary embodiment, M₁ in the formula (I) is either platinum or palladium, M₂ is silver and R₁, R₂, R₃ and R₄ are all triphenylphosphines and X is ClO₄.

The bimetallic complex of formula (II) is obtained by first reacting a metal acetylacetonate [M(acac)] with carbon disulfide to form a first metal complex. The reaction between the metal acetylacetonate and the carbon disulfide to form a first metal complex is shown below in the reaction (1):

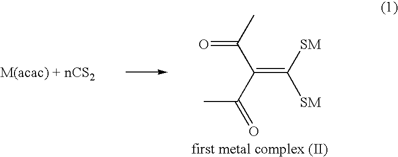

where M is a metal selected from groups I-III of the Periodic Table. Exemplary metal acetylacetonates are thallium acetylacetonates, lithium acetylacetonates, sodium acetylacetonates or potassium acetylacetonates. Examples of the metal M are thallium, lithium, sodium, or potassium.

The first metal complex (II) produced in the reaction is generally in the form of a precipitate. The reaction (1) is conducted for a period of time of greater than or equal to about 10 minutes to about 20 minutes, about 20 minutes to about 30 minutes, about 30 minutes to about 40 minutes, about 40 minutes to about 60 minutes, about 60 minutes to about 80 minutes, about 80 minutes to about 100 minutes, or greater than or equal to about 100 minutes, after which the excess disulfide is removed using a gentle stream of nitrogen. The resulting solid is then dissolved in a first solvent, filtered off and air dried.

The first metal complex (II) is then dissolved in a second solvent to which is added equimolar amounts of [M₁Cl₂(NCPh)₂] and a phosphine, to form a second metal complex (III). In one embodiment, the phosphine is a triarylphosphine, an alkydiarylphosphine, a dialkylarylphosphine or a trialkylphosphine. In an exemplary embodiment, the phosphine is a triphenylphosphine. The reaction between the first metal complex, the [M₁Cl₂(NCPh)₂] and the (PPh₃) to form the second metal complex is shown in the reaction (2) below:

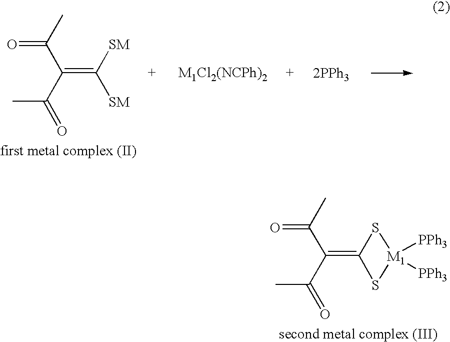

where M and M₁ are denoted above. Following the reaction, the suspension obtained from the reaction is filtered and washed in a second solvent and dried to yield the second metal complex [M₁(η²-S₂C═C{C(O)Me}₂}(PPh₃)₂].

As noted above, the first solvent is used to dissolve the first metal complex (II) produced in the reaction (1). The first solvent can comprise an alcohol, amide, ketone, nitrile, sulfoxide, sulfone, thiophene, ester, amide, ether or the like, or a combination comprising at least one of the foregoing solvents. In one embodiment, the first solvent is methanol, ethanol, propanol, isopropanol, butanol, glycerol, ethylene glycol, diethylene glycol, triethylene glycol, N-methylpyrollidinone, N,N-dimethylformamide, N,N-dimethylacetamide, acetone, methyl ethyl ketone, acetonitrile, dimethylsulfoxide, diethyl sulfone, diethyl ether, or the like, or a combination comprising at least one of the foregoing solvents. In an exemplary embodiment, the first solvent is diethyl ether.

The second solvent can be a polar solvent. The second solvent can comprise an alcohol, water, a ketone; a nitrile, a halogenated hydrocarbon, a sulfoxide, a sulfone, a thiophene, an acetate, an amide, or the like, or a combination comprising at least one of the foregoing solvents. The second solvent is isopropyl alcohol, dimethylsulfoxide, or the like, or a combination comprising at least one of the foregoing solvents. In an exemplary embodiment, the second solvent is a combination of water and dimethylsulfoxide. In an exemplary embodiment, the second solvent is dichloromethane.

To a solution of the second metal complex [M₁(η²-S₂C═C{C(O)Me}₂}(PPh₃)₂] in a third solvent is added an equimolar amount of a metal salt (M₂X) and triphenylphosphine to form the catalytic metal complex I. In one embodiment, the metal salt is a silver salt. In another embodiment, the silver salt is silver perchlorate. The reaction between the second metal complex, the silver salt and the triphenylphosphine is shown in the reaction (3) below:

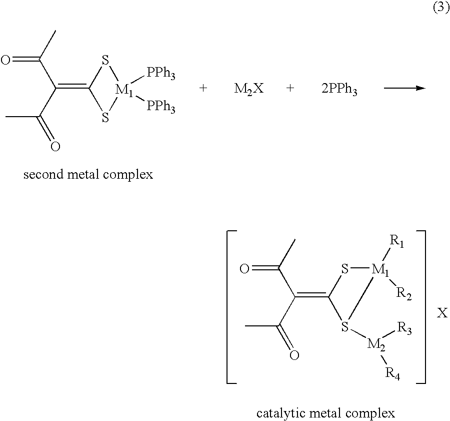

where M₁, M₂, R₁, R₂, R₃, R₄ and X are denoted above. The third solvent, like the second solvent is a polar solvent and can be selected from the list provided above. In an exemplary embodiment, the third solvent is acetone. The product obtained as a result of the reaction (3) is then stirred in the dark following which it was concentrated. Diethyl ether was then added to the concentrate to precipitate a solid that was filtered, washed with additional diethyl ether and suction dried.

The catalytic metal complex may be present in the catalyst composition in an amount greater than about 0.025 mole percent. The amount selection may be based on end use parameters, economic considerations, desired efficacy, and the like. In one embodiment, the amount is in a range of from about 0.025 mole percent to about 0.2 mole percent, from about 0.2 mole percent to about 1 mole percent, from about 1 mole percent to about 5 mole percent, from about 5 mole percent to about 10 mole percent, from about 10 mole percent to about 25 mole percent, from about 25 mole percent to about 35 mole percent, from about 35 mole percent to about 45 mole percent, from about 45 mole percent to about 50 mole percent, or greater than about 50 mole percent. An exemplary amount of the catalytic metal complex in the catalyst composition is about 1.5 mole percent to about 5 mole percent.

The porous substrate may include an inorganic material. Suitable inorganic materials may include, for example, inorganic oxides, inorganic carbides, inorganic nitrides, inorganic hydroxides, inorganic oxides, inorganic carbonitrides, inorganic oxynitrides, inorganic borides, or inorganic borocarbides. In one embodiment, the inorganic oxide may have hydroxide coatings. In one embodiment, the inorganic oxide may be a metal oxide. The metal oxide may have a hydroxide coating. Other suitable metal inorganics may include one or more metal carbides, metal nitrides, metal hydroxides, metal carbonitrides, metal oxynitrides, metal borides, or metal borocarbides. Metallic cations used in the foregoing inorganic materials can be transition metals, alkali metals, alkaline earth metals, rare earth metals, or the like.

Examples of suitable inorganic oxides include silica (SiO₂), alumina (Al₂O₃), titania (TiO₂), zirconia (ZrO₂), ceria (CeO₂), manganese oxide (MnO₂), zinc oxide (ZnO), iron oxides (e.g., FeO, β-Fe₂O₃, γ-Fe₂O₃, ε-Fe₂O₃, Fe₃O₄, or the like), calcium oxide (CaO), and manganese dioxide (MnO₂ and Mn₃O₄). Examples of suitable inorganic carbides include silicon carbide (SiC), titanium carbide (TiC), tantalum carbide (TaC), tungsten carbide (WC), hafnium carbide (HfC), or the like. Examples of suitable nitrides include silicon nitrides (Si₃N₄), titanium nitride (TiN), or the like. Examples of suitable borides include lanthanum boride (LaB₆), chromium borides (CrB and CrB₂), molybdenum borides (MoB₂, Mo₂B₅ and MoB), tungsten boride (W₂B₅), or the like. An exemplary inorganic porous substrate is alumina. The alumina may be crystalline or amorphous.

As noted above, the substrate is porous. In one embodiment, the average pore size of the substrate is controlled and selected to reduce or eliminate poisoning. Poisoning may affect catalytic ability, and may be by aromatic species present in the reductant or in the exhaust gas stream.

The substrate may have average diameters of pore greater than about 2 nanometers. In one embodiment, the substrate may have average pores sizes in a range of from about 2 nanometers to about 3 nanometers, from about 3 nanometers to about 50 nanometers, from about 50 nanometers to about 70 nanometers, from about 70 nanometers to about 100 nanometers, from about 100 nanometers to about 150 nanometers, from about 150 nanometers to about 170 nanometers, from about 170 nanometers to about 200 nanometers, from about 200 nanometers to about 250 nanometers, from about 250 nanometers to about 300 nanometers, from about 300 nanometers to about 350 nanometers, from about 350 nanometers to about 450 nanometers, from about 450 nanometers to about 500 nanometers, or greater than about 500 nanometers. The average pore size may be measured using nitrogen measurements (BET).

The porous substrate may have a surface area greater than about 0.5 m²/gram. In one embodiment, the surface area is in a range of from about 0.5 m²/gram to about 10 m²/gram, from about 10 m²/gram to about 100 m²/gram, from about 100 m²/gram to about 200 m²/gram, or from about 200 m²/gram to about 1200 m²/gram. In one embodiment, the porous substrate has a surface area that is in a range from about 0.5 m²/gram to about 200 m²/gram. In one embodiment, the porous substrate has a surface area in a range of from about 200 m²/gram to about 250 m²/gm, from about 250 m²/gram to about 500 m²/gm, from about 500 m²/gram to about 750 m²/gm, from about 750 m²/gram to about 1000 m²/gm, from about 1000 m²/gram to about 1250 m²/gm, from about 1250 m²/gram to about 1500 m²/gm, from about 1500 m²/gram to about 1750 m²/gm, from about 1750 m²/gram to about 2000 m²/gm, or greater than about 2000 m²/gm.

The porous substrate may be present in the catalyst composition in an amount that is greater than about 50 mole percent. In one embodiment, the amount present is in a range of from about 50 mole percent to about 60 mole percent, from about 60 mole percent to about 70 mole percent, from about 70 mole percent to about 80 mole percent, from about 80 mole percent to about 90 mole percent, from about 90 mole percent to about 95 mole percent, from about 95 mole percent to about 98 mole percent, from about 98 mole percent to about 99 mole percent, from about 99 mole percent to about 99.9975 mole percent, of the catalyst composition.

In one method of manufacturing, the catalytic metal complex and a reactive solution to prepare a porous substrate is mixed in a vessel with a substrate precursor, a suitable solvent, a modifier, and a suitable templating agent. The substrate precursor is selected as an inorganic alkoxide. The substrate precursor is initially in the form of a sol, and is converted to a gel by the sol gel process. The catalytic metal complex may be impregnated into the gel by incipient wetness impregnation. The gel is filtered, washed, dried and calcined to yield a solid catalyst composition that includes the catalytic metal complex disposed on a porous substrate.

In one embodiment, the catalytic metal complex may be a part of the reactive solution. The sol can include the catalytic metal complex prior to gelation. After gelation, the gel is filtered, washed, and dried to yield a catalyst composition that includes the catalytic metal complex disposed on a porous substrate.

In one embodiment, the gel may be subjected to supercritical extraction in order to produce the porous substrate. Carbon dioxide can be used as the supercritical fluid to facilitate the supercritical extraction.

The drying is conducted at temperatures in a range of from about 50 degrees Celsius to about 60 degrees Celsius, from about 60 degrees Celsius to about 70 degrees Celsius, from about 70 degrees Celsius to about 80 degrees Celsius, from about 80 degrees Celsius to about 90 degrees Celsius, or from about 90 degrees Celsius to about 100 degrees Celsius. In one embodiment, the calcination is conducted at a temperature of about 80 degrees Celsius. The calcination may be conducted for a time period of from about 10 minutes to about 30 minutes, from about 30 minutes to about 60 minutes, from about 60 minutes to about 1 hour, from about 1 hour to about 10 hours, from about 10 hours to about 24 hours, or from about 24 hours to about 48 hours.

In one method of manufacturing the catalyst composition, a reactive solution includes a substrate precursor and is mixed in a vessel with a suitable solvent, a modifier, and a suitable templating agent. The substrate precursor may include an inorganic alkoxide. The reactive solution may be in the form of a sol, and may convert to a gel by the sol gel process. The gel is calcined to form a solid. The solid is coated with a solution of the catalytic metal complex to form a washcoated substrate. The solution of the catalytic metal complex includes the catalytic metal complex and a solvent. Suitable catalytic metal complexes and solvents are listed below. The coating process may include dip coating, spin coating, centrifuging, spray coating, painting by hand or by electrostatic spray painting, or the like.

The wash-coated substrate is subjected to the drying process listed above, to form the catalyst composition. The drying process is conducted at the temperatures and for the times listed above.

Suitable inorganic alkoxides may include tetraethyl orthosilicate, tetramethyl orthosilicate, aluminum isopropoxide, aluminum tributoxide, aluminum ethoxide, aluminum-tri-sec-butoxide, aluminum tert-butoxide, antimony (III) ethoxide, antimony (III) isopropoxide, antimony (III) methoxide, antimony (III) propoxide, barium isopropoxide, calcium isopropoxide, calcium methoxide, chloro triisopropoxy titanium, magnesium di-tert-butoxide, magnesium ethoxide, magnesium methoxide, strontium isopropoxide, tantalum (V) butoxide, tantalum (V) ethoxide, tantalum (V) ethoxide, tantalum (V) methoxide, tin (IV) tert-butoxide, diisopropoxytitanium bis(acetylacetonate) solution, titanium (IV) (triethanolaminato) isopropoxide solution, titanium (IV) 2-ethylhexyloxide, titanium (IV) bis(ethyl acetoacetato)diisopropoxide, titanium (IV) butoxide, titanium (IV) butoxide, titanium (IV) diisopropoxide bis(2,2,6,6-tetramethyl-3,5-heptanedionate), titanium (IV) ethoxide, titanium (IV) isopropoxide, titanium (IV) methoxide, titanium (IV) tert-butoxide, vanadium (V) oxytriethoxide, vanadium (V) oxytriisopropoxide, yttrium (III) butoxide, yttrium (III) isopropoxide, zirconium (IV) bis(diethyl citrato)dipropoxide, zirconium (IV) butoxide, zirconium (IV) diisopropoxidebis (2,2,6,6-tetramethyl-3,5-heptanedionate), zirconium (IV) ethoxide, zirconium (IV) isopropoxide zirconium (IV) tert-butoxide, zirconium (IV) tert-butoxide, or the like, or a combination comprising at least one of the foregoing inorganic alkoxides. An exemplary inorganic alkoxide is aluminum sec-butoxide.

The reactive solution contains an inorganic alkoxide in an amount greater than about 1 weight percent based on the weight of the reactive solution. In one embodiment, the reactive solution contains an inorganic alkoxide in an amount in a range of from about 1 weight percent to about 5 weight percent, from about 5 weight percent to about 10 weight percent, from about 10 weight percent to about 15 weight percent, from about 15 weight percent to about 20 weight percent, from about 20 weight percent to about 30 weight percent, from about 30 weight percent to about 40 weight percent, from about 40 weight percent to about 50 weight percent, or greater than about 50 weight percent.

Suitable solvents for use in the incipient wetness method or for use in the wash-coating process include aprotic polar solvents, polar protic solvents, and non-polar solvents. Suitable aprotic polar solvents may include propylene carbonate, ethylene carbonate, butyrolactone, acetonitrile, benzonitrile, nitromethane, nitrobenzene, sulfolane, dimethylformamide, N-methylpyrrolidone, or the like. Suitable polar protic solvents may include water, nitromethane, acetonitrile, and short chain alcohols. Suitable short chain alcohols may include one or more of methanol, ethanol, propanol, isopropanol, butanol, or the like. Suitable non polar solvents may include benzene, toluene, methylene chloride, carbon tetrachloride, hexane, diethyl ether, or tetrahydrofuran. Co-solvents may also be used. Ionic liquids may be used as solvents during gelation. Exemplary solvents include 2-butanol and 2-propanol.

Solvents may be present in an amount greater than about 0.5 weight percent. In one embodiment, the amount of solvent present may be in a range of from about 0.5 weight percent to about 1 weight percent, from about 1 to about 20 weight percent, from about 20 weight percent to about 50 weight percent, from about 50 weight percent to about 100 weight percent, from about 100 weight percent to about 200 weight percent, from about 200 weight percent to about 300 weight percent, from about 300 weight percent to about 400 weight percent, from about 400 weight percent to about 500 weight percent, from about 500 weight percent to about 600 weight percent, from about 600 weight percent to about 700 weight percent, from about 700 weight percent to about 800 weight percent, or greater than about 800 weight percent, based on the total weight of the reactive solution. Selection of the type and amount of solvent may affect or control the amount of porosity generated in the catalyst composition, as well as affect or control other pore characteristics.

The catalyst composition may be manufactured in powdered form. The catalyst composition may be manufactured in the form of a monolith. In one embodiment, the catalyst composition may be disposed on a prefabricated monolithic core. The prefabricated monolith core with the catalyst composition disposed thereon may be subjected to freeze drying as well as to calcining to produce a monolithic catalyst composition. In one embodiment, the prefabricated monolith core with the catalyst composition disposed thereon may be subjected to supercritical fluid extraction and to calcining to produce a monolithic catalyst composition.

After formation, the catalyst composition may be disposed in an exhaust gas stream of an automobile or a locomotive or another engine having NOx therein. The catalyst composition contacts and reduces NOx to nitrogen in the presence of a reducing agent. The catalyst composition may be disposed into the exhaust gas stream either in powdered form or in the form of a monolith.

### EXAMPLES

The following examples illustrate methods and embodiments in accordance with the invention, and as such should not be construed as imposing limitations upon the claims. These examples demonstrate the manufacture of the catalyst compositions described herein and demonstrate their performance compared with other catalyst compositions that are commercially available. Unless specified otherwise, all components are commercially available from common chemical suppliers such as Aldrich (Milwaukee, Wis.), Alpha Aesar, Inc. (Ward Hill, Mass.), Spectrum Chemical Mfg. Corp. (Gardena, Calif.), and the like.

### Example 1

### Preparation of a Catalyst Composition

This example was conducted to demonstrate the manufacturing of the catalytic metal complex. Two different catalytic metal complexes were synthesized. The catalytic metal complexes were either a silver-platinum (Pt—Ag) catalytic metal complex or a silver-palladium (Pd—Ag) catalytic metal complex. In the preparation of the silver-platinum catalytic metal complex or in the preparation of the silver-palladium catalytic metal complex, thallium acetylacetonate [Tl(acac)] is reacted with carbon disulfide to produce a thallium complex (hereinafter Tl Complex IIa) (see reaction scheme (4) below). The Tl Complex IIa was then reacted with [MCl₂(NCPh)₂] and triphenylphosphine (PPh₃) (see reaction (5) below) to produce either an intermediate platinum metal complex (hereinafter Pt Complex IIIa) or an intermediate palladium metal complex (hereinafter Pd Complex IIIb). The Pt Complex IIIa or the Pd Complex IIIb are then reacted with silver perchlorate and additional triphenylphosphine to produce a silver-platinum catalyst metal complex (Ag—Pt complex Ia) or a silver-palladium catalyst metal complex (Ag—Pd complex Ib) (see reaction (6) below). The silver-platinum catalyst metal complex or the silver-palladium catalyst metal complex is then disposed upon a porous aluminum substrate to produce the catalyst composition.

### Preparation of the Tl Complex II

The thallium complex designated as Tl Complex II or [Tl₂{η²-S₂C═C[C(O)Me}₂}], is prepared by as follows. Thallium acetylacetonate ([Tl(acac)]) (2.07 grams (g), 6.82 millimoles (mmol)) was suspended in carbon disulfide (CS₂) (30 milliliters (ml)). Immediate reaction occurred as shown in the reaction scheme (IV) below to give an orange precipitate of the Tl Complex II. The suspension was stirred for 30 minutes and excess CS₂ was removed under a gentle stream of nitrogen (N₂). The resulting solid was stirred with diethyl ether for 40 minutes, filtered off and air dried. The yield was 1.9654 g, 98.8%.

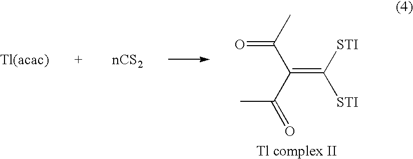

### Preparation of the Intermediate Platinum Metal Complex and the Intermediate Palladium Metal Complex

The intermediate palladium metal complex and the intermediate platinum metal complex designated as Pd Complex IIIb, also known as [Pd{η²-S₂C═C{C(O)Me}₂}(PPh₃)₂], and Pt Complex IIIa, also known as [Pt{η²-S₂C═C{C(O)Me}₂}(PPh₃)₂], are prepared as follows. To a suspension of [Tl₂{η²-S₂C═C[C(O)Me}₂}] (Tl complex II) (0.513 g, 0.88 mmol) in dichloromethane (80 ml for Pd, 130 ml for Pt) is added an equimolar amount of [MCl₂(NCPh)₂], where M is either Pd or Pt (0.3375 g, 0.88 mmol for Pd or 0.4156 g, 0.88 mmol for Pt) and 2 equivalents of PPh₃ (0.4616 g, 1.76 mmol). The reactions are shown in the reaction scheme (5) below. After 30 minutes for Pd or 24 hrs for Pt of stirring, the suspension is filtered through Celite, and the solution is concentrated under vacuum. 60 ml of diethyl ether was added to precipitate the Pd Complex IIIb or the Pt Complex IIIa as shiny yellow solids. Both precipitates were filtered, washed with diethyl ether and air-dried. The resulting yield is 0.6064 g, 86% for the Pd complex IIIb, and 0.7422 g, 94% for the Pt complex IIIa. For the Pd complex IIIb, the ¹H NMR (500 MHz) is as follows: CD₂Cl₂:δ=2.19 (s, 6H), 7.27-7.43 (m, 30H). For the Pt complex IIIa, the ¹HNMR (500 MHz) is as follows: CD₂Cl₂:δ=2.18 (s, 6H), 7.26-7.48 (m, 30H).

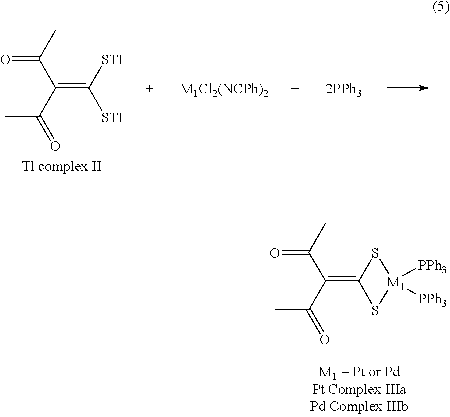

### Preparation of the Silver-Platinum Catalyst Metal Complex or the Silver-Palladium Catalyst Metal Complex

The silver-palladium catalyst metal complex designated as Pd—Ag Complex Ib, also known as {Pd(PPh₃)₂}{Ag(PPh₃)₂}{μ²,η²-(S,S′)-{S₂C═C{C(O)Me}₂}}]—ClO₄, and silver-platinum catalyst metal complex designated as Pt—Ag Complex Ia, also known as {Pt(PPh₃)₂}{Ag(PPh₃)₂}{μ²,η²-(S,S′)-{S₂C═C{C(O)Me}₂}}]-ClO₄, are prepared as follows. The reactions are depicted in the reaction scheme (6) below. A solution of the Pd Complex IIIb is mixed with 0.3495 g in 80 ml acetone to achieve 0.391 mmol for the Pd complex IIIb. A solution of the Pt Complex IIIa is mixed with 0.3150 g in 135 ml acetone to achieve 0.391 mmol for the Pt Complex IIIa. To the solutions of Pd complex IIIb, or Pt complex IIIa, is added an equimolar amount of AgClO₄ (0.0811 g, 0.0391 mmol) and 2 equivalents of PPh₃ (0.2051 g, 0.782 mmol). The resulting solution is stirred in the dark for about 2 to about 3 hours. The solutions were then concentrated and diethyl ether is added to precipitate a yellow solid that is filtered, washed with diethyl ether and suction dried. The resulting yield is 0.4062 g, 77% for the Pd—Ag Complex Ib, and 0.4608 g, 72% for the Pt—Ag Complex Ia.

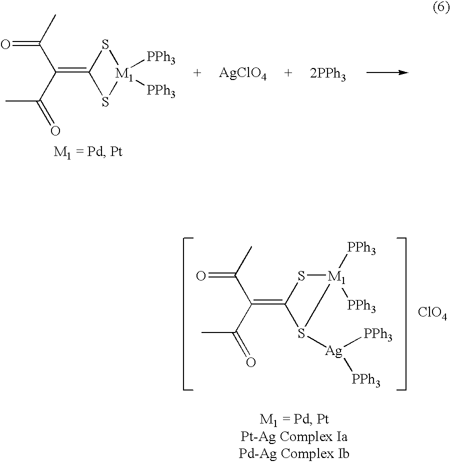

The testing data for the Pd—Ag Complex Ib is as follows: ¹H NMR, CD₂Cl₂:δ=2.00 (s, 6H), 7.18-7.52 (m, 60H); ³¹P{H} NMR, CD₂Cl₂ (25° C.): δ=9-13 (v br, AgPPh₃), 31.03 (s, PdPPh₃), ³¹P{H} NMR, CD₂Cl₂ (−60° C.): δ=9.01 [dd, J(³¹P¹⁰⁹Ag)=465.62 Hz, J(³¹P¹⁰⁷Ag)=403.43 Hz)], 27-37 (v br, PdPPh₃).

The testing data for the Pt—Ag Complex Ia is as follows: ¹H NMR, CD2Cl2: δ=2.01 (s, 6H), 7.18-7.51 (m, 60H); ³¹P{H} NMR, CD₂Cl₂ (25° C.): δ=9.4-13 (v br, AgPPh₃), 19.05 [s with ¹⁹⁵Pt satellites, J(³¹P¹⁹⁵Pt)=3081 Hz], ³¹P{H} NMR, CD₂Cl₂ (−60° C.): δ=9.01 [dd, J(³¹P¹⁰⁹Ag)=469.56 Hz, J(³¹P¹⁰⁷Ag)=406.56 Hz)], 18-21 (vbr, PtPPh₃)

### Example 2

### Production of the Catalyst Composition for Testing

The catalytic metal complex prepared in the Example 1 was then disposed on a porous alumina substrate to prepare the catalyst composition. The catalytic metal complex was then disposed on the porous alumina substrate by an incipient wetness impregnation method.

600 microliters of a solution containing the Pd—Ag Complex Ib or the Pt—Ag Complex Ia were blended with either 0.3 grams of porous gamma-alumina (hereinafter Al₂O₃) or 0.3 grams of alumina having 2 mole percent of silver disposed thereon (hereinafter 2 mole % Ag/Al₂O₃). The solution was a 0.1 M solution of the Pd—Ag Complex Ib or the Pt—Ag Complex Ia in dichloromethane. After impregnating the Al₂O₃ or the 2 mole % Ag/Al₂O₃ with the Pd—Ag Complex Ib or the Pt—Ag Complex Ia, the Al₂O₃ and the 2 mole % Ag/Al₂O₃ were dried in a vacuum oven at 80° C. to remove the dichloromethane and yield the respective catalyst compositions. The catalyst compositions containing the Al₂O₃ were labeled 2 mole % Pd—Ag/Al₂O₃ and 2 mole % Pt—Ag/Al₂O₃ respectively, while the catalyst compositions containing the 2 mole % Ag/Al₂O₃ were labeled 0.2 mole % Pd—Ag on 2 mole % Ag/Al₂O₃ and 0.2 mole % Pt—Ag on 2 mole % Ag/Al₂O₃ respectively

### Test Conditions

The test conditions for the aforementioned catalyst compositions are as follows. The catalysts are pretreated with 7 percent H₂O and 50 ppm SO₂, and 12 percent O₂ for 7 hours at 450 degrees Celsius to “age” or “sulfur soak” the catalysts. The samples from the Examples listed above are disposed in a high throughput screen (HTS) reactor to determine their nitrogen oxide conversion capabilities in a simulated exhaust gas stream. The reactor has 32 tubes, each tube of which can receive a catalyst composition. No catalyst is placed in the tube #1. Tube #1 is used to measure the nitrogen oxide (NOₓ) concentration in the exhaust gas stream. The catalyst composition samples are placed in the other tubes and the reduction in NOx concentration is measured. The reduction in NOx concentration relates to catalytic activity of the catalyst compositions.

The simulated exhaust gas stream contains an exhaust gas composition and a reductant. Three samples of each catalyst are tested in each run and each catalyst is tested at three temperatures. The temperatures are 275 degrees Celsius, 375 degrees Celsius and 425 degrees Celsius. Following the testing, the reductant is burned off so as to allow another reductant to be tested.

The simulated exhaust gas composition is composed of 12 percent O₂, 600 ppm NO, 7 percent H₂O, 1 ppm SO₂ and the balance is N₂.

Three reductants are tested. The first reductant is so-called moctane, which is composed of 2,4, dimethylhexane (5 weight percent), 3,4, dimethylhexane (2 weight percent), 2,2,4, trimethylpentane (57 weight percent), octane (7 weight percent) and toluene (29 weight percent), and containing linear, cyclic and aromatic hydrocarbons that mimics a light fraction of diesel fuel. The second reductant is C₁-C₃, which is composed of methane (5,500 ppm), ethane (30,900 ppm), propane (27,500 ppm) with the balance being N₂. A third reductant is a moctane/C₁-C₃ mixture in a weight ratio of 50:50.

A series of catalytic compositions were tested. These are described in Table 1 below.

TABLE 1

| Sample | Catalytic | |
|---|---|---|
| No. | Composition | Description |
| 1 | Al₂O₃ support | Gamma alumina catalyst support surface |
| | | area 200 m²/gm commercially available |
| | | from St. Gobain-Norton. |
| 2 | 2 mole % Ag/Al₂O₃ | Prepared by incipient wetness of the |
| | | Al₂O₃ support with AgNO₃ solution |
| | | followed by calcination at 650° C. |
| 3 | 1 mole % Pt/Al₂O₃ | Prepared by incipient wetness of the |
| | | Al₂O₃ support with PtCl₂ solution |
| | | followed by calcination at 650° C. |
| 4 | 0.2 mole % Pd—Ag | See Examples 1-2 |
| | complex on | |
| | 2% Ag/Al₂O₃ | |
| 5 | 2 mole % Pd—Ag | See Examples 1-2 |
| | complex/Al₂O₃ | |
| 6 | 0.2 mole % Pt—Ag | See Examples 1-2 |
| | complex on | |
| | 2% Ag/Al₂O₃ | |
| 7 | 2 mole % Pt—Ag | See Examples 1-2 |
| | complex/Al₂O₃ | |

Data is presented as percent NOx conversion by measuring the NOx concentration through tube #1 with no catalyst present and measuring the NOx concentration over the other tubes with catalysts and determining the percent change. The bar graphs show average NOx conversion of 3 samples (lower portion of each bar) and the standard deviation (the upper portion of each bar).

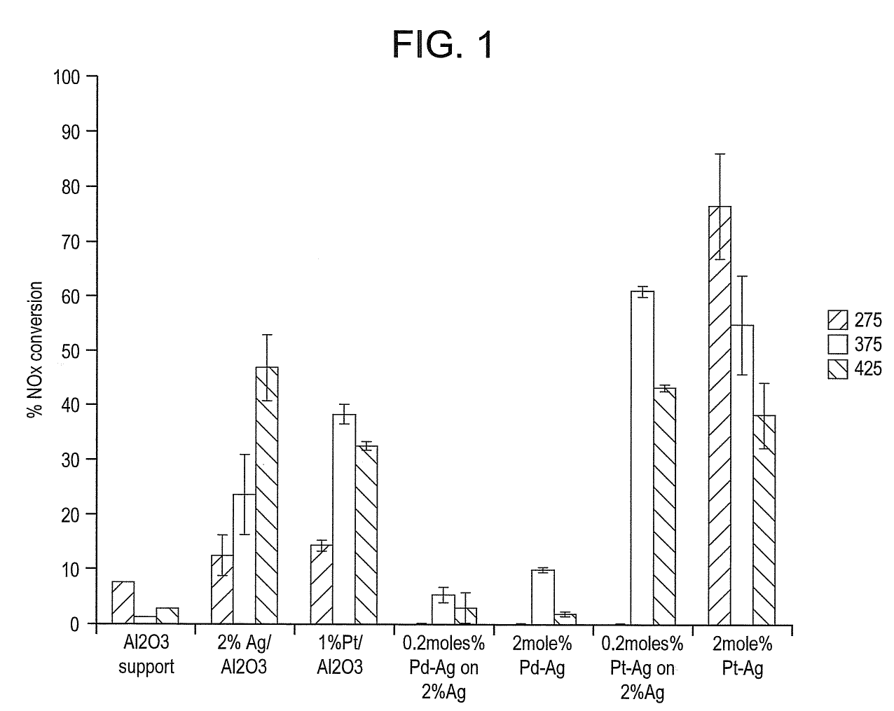

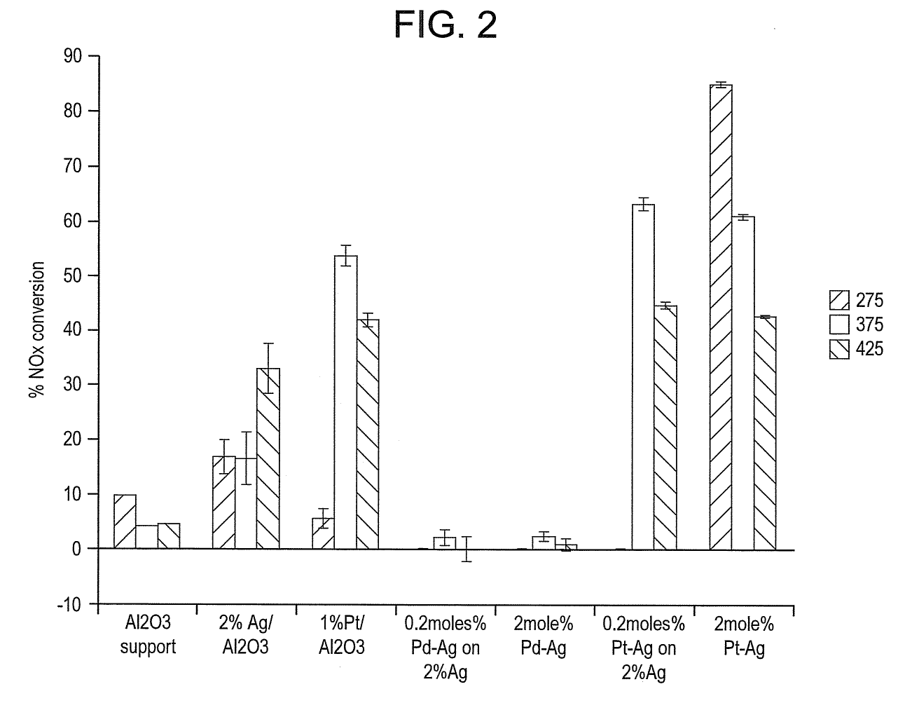

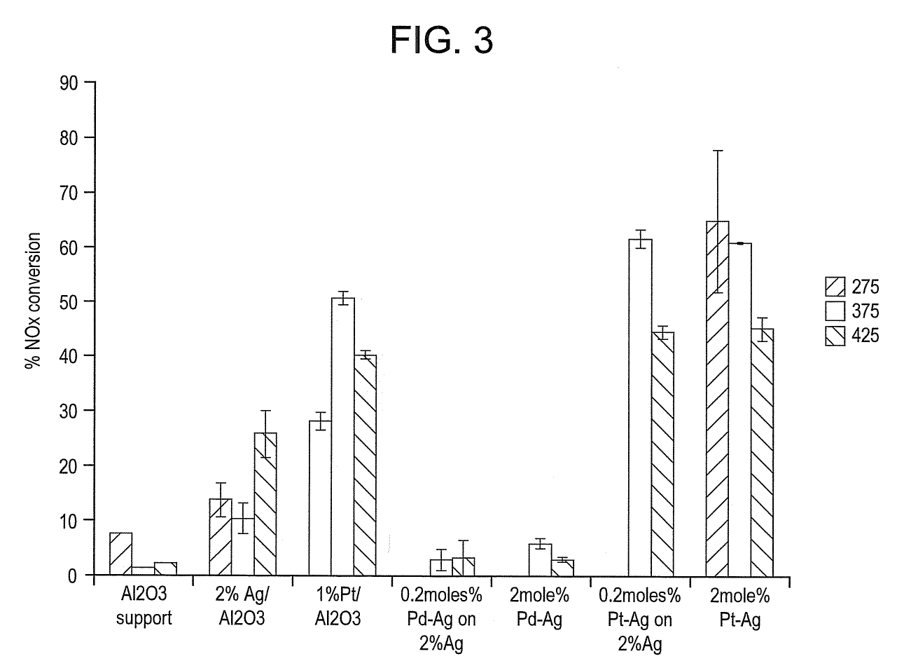

The NOx conversion results for the catalyst compositions with the three reductants are shown in FIGS. 1-3. Referring to FIG. 1, the reductant is Moctane, while in FIG. 2 the reductant is C₁-C₃, and in FIG. 3 the reductant is a Moctane/C₁-C₃ mixture.

FIG. 1 is a bar graph depicting NOx conversion at three different temperatures, using Moctane as the reductant, and the catalyst compositions of the Samples described in Table 1. FIG. 1 shows that the NOx conversion rate is affected by the catalyst composition. Sample 6, which represents the catalyst composition comprising 0.2 mole % Pt—Ag on 2 mole % Ag/Al₂O₃ produces relatively superior results of approximately 60% and 43% NOx conversion at 375° C. and 425° C. respectively as compared to the other Samples. Sample 7, which represents the catalyst composition comprising 2 mole % Pt—Ag/Al₂O₃ produces relatively superior results of approximately 75% NOx conversion at lower temperatures as compared to the other Samples maintaining good performance at higher temperatures.

FIG. 2 is a bar graph depicting NOx conversion at three different temperatures, using C₁-C₃ as the reductant, and the catalyst compositions of the Samples described in Table 1. FIG. 2 shows that NOx conversion rate is affected by the catalyst composition. Once again sample 7, which represents the catalyst composition comprising 2 mole % Pt—Ag/Al₂O₃, produces relatively superior results of approximately 85% NOx conversion at lower temperatures as compared to the other Samples.

FIG. 3 is a bar graph depicting NOx conversion at three different temperatures, using a Moctane/C₁-C₃ mixture as the reductant, and the catalyst compositions of the Samples described in Table 1. FIG. 3 shows that NOx conversion rate is affected by the catalyst composition. Once again sample 7, which represents the catalyst composition comprising 2 mole % Pt—Ag/Al₂O₃, produces relatively superior results of approximately 65% NOx conversion at lower temperatures as compared to the other samples.

As can be seen from the above examples, the catalyst composition can advantageously reduce NOx to nitrogen at temperatures of about 250 to about 400° C., in the presence of reductants such as C₁-C₃ hydrocarbons, C₆-C₁₆ hydrocarbons, gasoline, diesel fuel, a light fraction of diesel fuel or the like, or a combination comprising at least one of the foregoing reductants.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product.

All ranges disclosed herein are inclusive of the endpoints, and the endpoints are combinable with each other. The terms “first,” “second,” and the like as used herein do not denote any order, quantity, or importance, but rather are used to distinguish one element from another. The use of the terms “a” and “an” and “the” and similar referents in the context of describing the invention (especially in the context of the following claims) are to be construed to cover both the singular and the plural, unless otherwise indicated herein or contradicted by context.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A catalyst composition comprising:
a bimetallic complex of silver and a second metal; the bimetallic complex being disposed upon a porous substrate; where the second metal is platinum, palladium, iron, cobalt, nickel, copper, cadmium or mercury and where atoms of silver and the second metal are bound by one or more bridging ligands, wherein the catalytic metal complex is capable of reducing or eliminating NOx in an exhaust gas stream in contact therewith.

2. The catalyst composition as defined in claim 1, wherein second metal is platinum.

3. The catalyst composition as defined in claim 1, wherein bridging ligands contain sulfur.

4. A catalyst composition, comprising:
a catalytic metal complex disposed upon a porous substrate; the catalytic metal complex having the structure in formula (I) 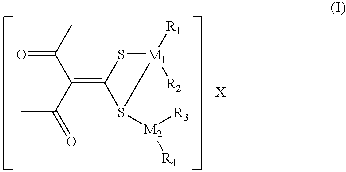
where M₁ is one of platinum, palladium, cobalt, nickel, copper, cadmium or mercury and M₂ is silver, R₁, R₂, R₃ and R₄ are phosphine and X is ClO₄, BF₄, or NO₃, wherein the catalytic metal complex is capable of reducing or eliminating NOx in an exhaust gas stream in contact therewith.

5. The catalyst composition as defined in claim 4, wherein M₁ is platinum or palladium.

6. The catalyst composition as defined in claim 4, wherein M₁ is platinum.

7. The catalyst composition as defined in claim 4, wherein the porous substrate comprises alumina.

8. The catalyst composition as defined in claim 4, wherein the pores have an average diameter of less than about 50 nanometers.

9. The catalyst composition as defined in claim 4, wherein the catalytic metal complex is capable of reducing or eliminating NOx in an exhaust gas stream in contact therewith in the presence of a hydrocarbon or mixture of hydrocarbons.

10. The catalyst composition as defined in claim 4, wherein the catalytic metal complex is capable of reducing or eliminating NOx in an exhaust gas stream in contact therewith in the presence of diesel fuel.

11. The catalyst composition as defined in claim 4, where R₁, R₂, R₃ and R₄ can be the same or different and can be a triarylphosphine, an alkydiarylphosphines, a dialkylarylphosphines or a trialkylphosphine

12. A catalyst composition, comprising:
a catalytic metal complex disposed upon a porous substrate; wherein the catalytic metal complex is a reaction product of a second metal complex, a silver salt and a second amount of a phosphine; and
the second metal complex being a reaction product of a first metal complex, M₁Cl₂(NCPh)₂ and a first amount of a phosphine, wherein M₁ is one of platinum, palladium, cobalt, nickel, copper, cadmium, or mercury; and the first metal complex being a reaction product of a metal acetylacetonate and a disulfide;
wherein the catalytic metal complex is capable of reducing or eliminating NOx in an exhaust gas stream in contact therewith.

13. The catalyst composition as defined in claim 12, wherein the metal acetylacetonate is thallium acetylacetonate.

14. The catalytic composition as defined in claim 12, where M₁ is platinum.

15. The catalyst composition as defined in claim 12, wherein the silver salt is silver perchlorate.

16. The catalyst composition as defined in claim 12, wherein the porous substrate comprises alumina.

17. The catalyst composition as defined in claim 12, wherein the catalytic metal complex is present in the catalyst composition in an amount of about 1.5 mole percent to about 5 mole percent.

18. The catalyst composition as defined in claim 12, wherein the catalyst composition is in the form of a monolith.

19. A method, comprising:
disposing a catalytic metal complex upon a porous substrate to form a catalyst composition; wherein the catalytic metal complex has the structure in formula (I) 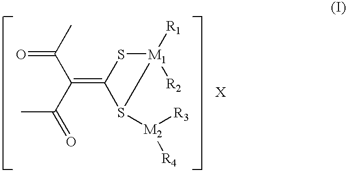
where M₁ is one of platinum, palladium, iron, cobalt, nickel, copper, cadmium or mercury and M₂ is silver, R₁, R₂, R₃ and R₄ are phosphines and X is ClO₄, BF₄, or NO₃; wherein the catalytic metal complex is capable of reducing or eliminating NOx in an exhaust gas stream in contact therewith.

20. The method of as defined in claim 19, further comprising drying the catalyst metal composition.

21. The method as defined in claim 19, wherein the wherein the catalytic metal complex is obtained by reacting a metal acetylacetonate with a disulfide to form a first metal complex as shown in reaction (1); 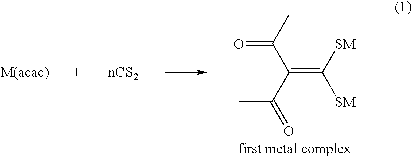
where M is a metal;
reacting the first metal complex with M₁Cl₂(NCPh)₂ and a first amount of triphenylphosphine to form a second metal complex as shown in reaction (2); 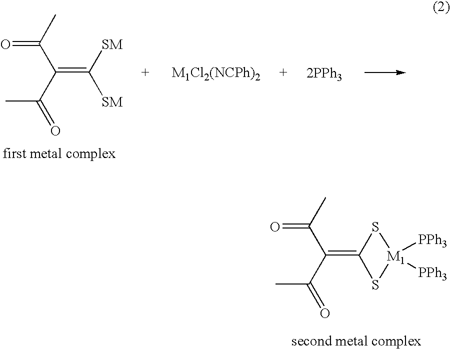
where M₁ is platinum, palladium, cobalt, nickel, copper, cadmium or mercury; and
reacting the second metal complex with a silver salt and a second amount of triphenylphosphine to form the catalytic metal complex as shown in the reaction (3) below; 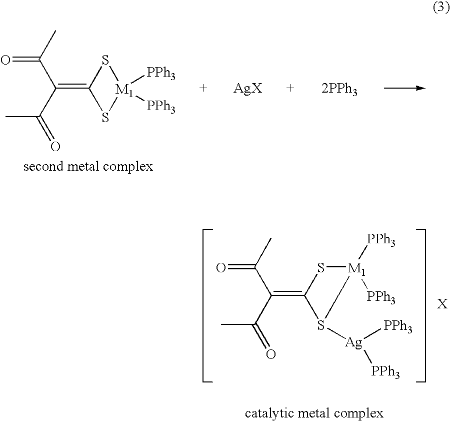
where X is ClO₄, BF₄, or NO₃.

22. The method as defined in claim 21, wherein the metal acetylacetonate is thallium acetylacetonate.

23. The method as defined in claim 21, where M₁ is platinum.

24. The method as defined in claim 19, further comprising contacting the catalyst composition to an exhaust gas stream having NOx therein such that the catalyst composition reduces or eliminates the NOx in the presence of a hydrocarbon reductant during determined operating conditions.

25. The method as defined in claim 24, wherein the hydrocarbon reductant is selected from the group consisting of C₁-C₃ hydrocarbons, C₆-C₁₆ hydrocarbons, gasoline, diesel fuel, a light fraction of diesel fuel and a mixture thereof.
